(19) United States
(12) Patent Application Publication
(10) Pub. No.: US 2017/0158408 A1
(43) Pub. Date: Jun. 8, 2017

(54) MICROWAVE PACKAGE

(71) Applicant: Graphic Packaging International, Inc., Atlanta, GA (US)

(72) Inventors: Fermin P. Resurreccion, JR., Thornton, CO (US); Vladimir C. Martinez, Aurora, CO (US)

(21) Appl. No.: 15/367,272

(22) Filed: Dec. 2, 2016

Related U.S. Application Data
(60) Provisional application No. 62/262,534, filed on Dec. 3, 2015.

(51) Int. Cl. B65D 81/34; B65D 77/20; H05B 6/64; B65B 25/22

(52) U.S. Cl. CPC B65D 81/3453; B65B 25/22; B65D 77/20; H05B 6/6494; B65D 2581/344; B65D 2581/3452

(57) ABSTRACT

A container for holding at least a first food item and a second food item. The container can comprise a sidewall with a microwave energy interactive layer. A shielded interior portion of an interior of the container can be defined by at least the microwave energy interactive layer and can be for at least partially receiving the first food item. An at least partially unshielded interior portion of the interior of the container can be at least partially defined by the sidewall and can be for at least partially receiving the second food item. A plurality of apertures can extend through at least the microwave energy interactive layer, and each aperture can have a characteristic dimension that is selected based on a cutoff frequency of a microwave oven to be sufficiently small so that substantially all microwave energy incident on the container is substantially prevented from passing through the apertures.

### CROSS-REFERENCE TO RELATED APPLICATIONS

This application claims the benefit of U.S. Provisional Patent Application No. 62/262,534, filed on Dec. 3, 2015.

### INCORPORATION BY REFERENCE

The disclosure of U.S. Provisional Patent Application No. 62/262,534, which was filed on Dec. 3, 2015, is hereby incorporated by reference for all purposes as if presented herein in its entirety.

### BACKGROUND OF THE DISCLOSURE

The present disclosure relates to constructs for holding food items. The constructs can be formed with microwave energy interactive materials.

### SUMMARY OF THE DISCLOSURE

In general, one aspect of the disclosure is generally directed to a container for holding at least a first food item and a second food item during exposure to microwave energy in a microwave oven having a cutoff frequency. The container can comprise a sidewall extending at least partially around an interior of the container. The sidewall can comprise at least a substrate layer and a microwave energy interactive layer. A shielded interior portion of the interior of the container can be at least partially defined by at least the microwave energy interactive layer of the sidewall. The shielded interior portion can be for at least partially receiving the first food item. An at least partially unshielded interior portion of the interior of the container can be at least partially defined by the sidewall. The at least partially unshielded interior portion can be for at least partially receiving the second food item. A plurality of apertures can extend through at least the microwave energy interactive layer, and each aperture of the plurality of apertures can have a characteristic dimension that is selected based on the cutoff frequency of the microwave oven to be sufficiently small so that substantially all microwave energy incident on the microwave energy interactive layer is substantially prevented from passing through the apertures.

In another aspect, the present disclosure is generally directed to a method of forming a container for holding at least a first food item and a second food item during exposure to microwave energy in a microwave oven having a cutoff frequency. The method can comprise obtaining a sidewall blank comprising at least a substrate layer and a microwave energy interactive layer. The microwave energy interactive layer can comprise a plurality of apertures, each extending through at least the microwave energy interactive layer. Each aperture of the plurality of apertures can have a characteristic dimension that is selected based on the cutoff frequency of the microwave oven to be sufficiently small so that substantially all microwave energy incident on the microwave energy interactive layer is substantially prevented from passing through the apertures. The method further can comprise forming a sidewall extending at least partially around an interior of the container with the sidewall blank. The forming the sidewall can comprise forming a shielded interior portion of the interior of the container. The shielded interior portion can be at least partially defined by the microwave energy interactive layer of the sidewall and can be for at least partially receiving the first food item. The forming the sidewall further can comprise forming an at least partially unshielded interior portion of the interior of the container. The at least partially unshielded interior portion can be at least partially defined by the sidewall and can be for at least partially receiving the second food item.

In another aspect, the present disclosure is generally directed to a package for being exposed to microwave energy in a microwave oven having a cutoff frequency. The package can comprise a container comprising a sidewall extending at least partially around an interior of the container. The sidewall can comprise at least a substrate layer and a microwave energy interactive layer. A shielded interior portion of the interior of the container can be at least partially defined by the microwave energy interactive layer of the sidewall, an at least partially unshielded interior portion of the interior of the container can be at least partially defined by the sidewall, and a plurality of apertures can extend through at least the microwave energy interactive layer. Each aperture of the plurality of apertures can have a characteristic dimension that is selected based on the cutoff frequency of the microwave oven to be sufficiently small so that substantially all microwave energy incident on the microwave energy interactive layer is substantially prevented from passing through the apertures. The package further can comprise a first food item at least partially disposed in the shielded interior portion for being shielded from microwave energy incident on the container by at least the microwave energy interactive layer; and a second food item at least partially disposed in the at least partially unshielded interior portion.

In another aspect, the present disclosure is generally directed to a method comprising obtaining a container comprising a sidewall extending at least partially around an interior of the container. The sidewall can comprise at least a substrate layer and a microwave energy interactive layer. A shielded interior portion of the interior of the container can be at least partially defined by at least the microwave energy interactive layer of the sidewall, an at least partially unshielded interior portion of the interior of the container can be at least partially defined by the sidewall, and a plurality of apertures can extend through at least the microwave energy interactive layer. The method further can comprise disposing a first food item in the shielded interior portion, disposing a second food item in the at least partially unshielded interior portion, and exposing the container to microwave energy in a microwave oven having a cutoff frequency. Each aperture of the plurality of apertures can have a characteristic dimension that is selected based on the cutoff frequency of the microwave oven to be sufficiently small so that the microwave energy interactive layer and the apertures substantially shield the first food item from the microwave energy.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a sidewall blank for forming a sidewall of a container according to a first exemplary embodiment of the disclosure.

FIG. 1A is a detail view of an aperture in a layer of the sidewall blank of FIG. 1.

FIG. 2 is a plan view of a bottom blank for forming a bottom wall of the container according to the first exemplary embodiment of the disclosure.

FIG. 3 is a perspective view of the container formed from the sidewall blank of FIG. 1 and the bottom blank of FIG. 2 according to the first exemplary embodiment of the disclosure.

FIG. 4 is a schematic side cross-sectional view of the container of FIG. 3 with two food items disposed therein according to the first exemplary embodiment of the disclosure.

FIG. 5 is a plan view of a bottom blank according to a second exemplary embodiment of the disclosure.

FIG. 6 is a perspective view of a container formed from the sidewall blank of FIG. 1 and the bottom blank of FIG. 5 according to the second exemplary embodiment of the disclosure.

FIGS. 7 and 8 are plan views of a sidewall blank and a bottom blank, respectively, for forming a container according to a third exemplary embodiment of the disclosure.

FIGS. 9 and 10 are plan views of a sidewall blank and a bottom blank, respectively, for forming a container according to a fourth exemplary embodiment of the disclosure with triangular apertures.

FIG. 11 is schematic a perspective view of a container according to a fifth exemplary embodiment of the disclosure.

FIG. 12 is a schematic perspective cross-sectional view of the container of FIG. 11.

Corresponding parts are designated by corresponding reference numbers throughout the drawings.

### DETAILED DESCRIPTION OF THE EXEMPLARY EMBODIMENTS

The present disclosure relates generally to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to a container for holding, heating, cooking, and/or shielding food items or various other articles. However, in other embodiments, the container can be used to form other non-food containing articles or may be used for refrigerating or other uses. In this specification, the terms “inner,” “interior,” “outer,” “exterior,” “lower,” “bottom,” “upper,” and “top” indicate orientations determined in relation to fully erected and upright cartons.

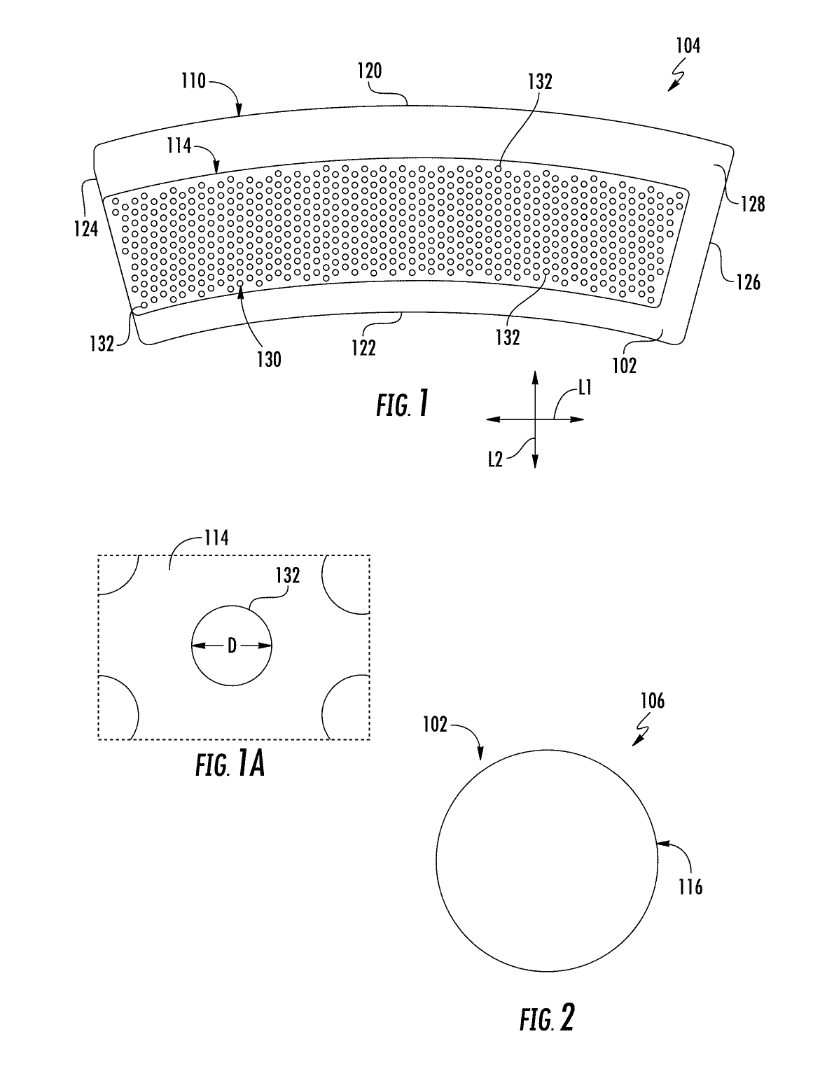

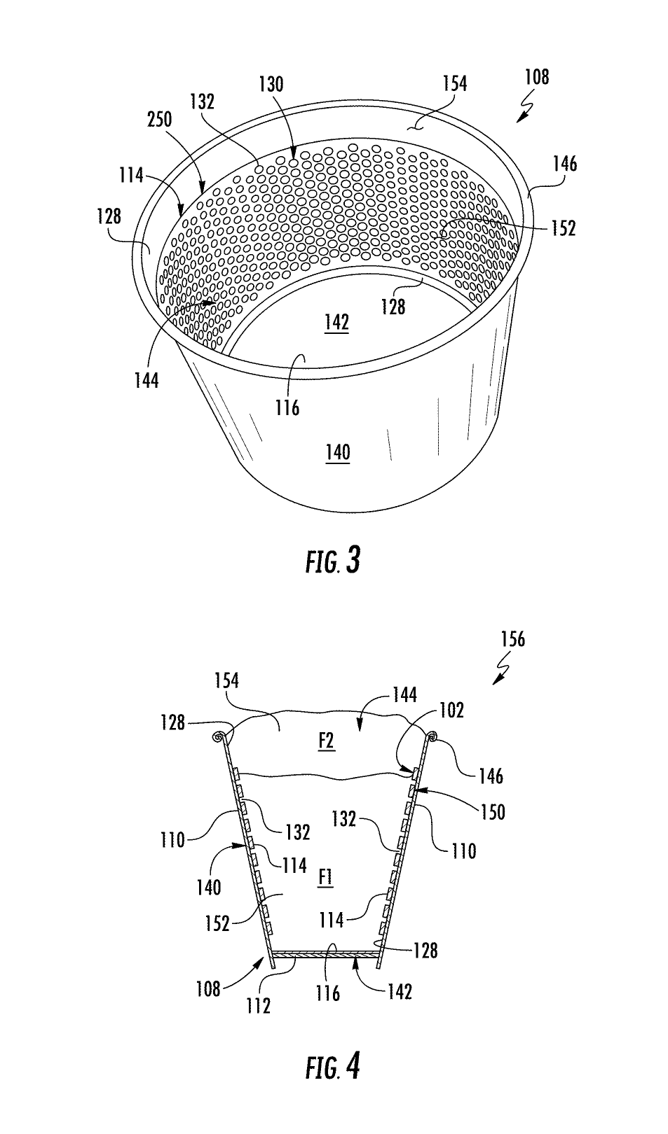

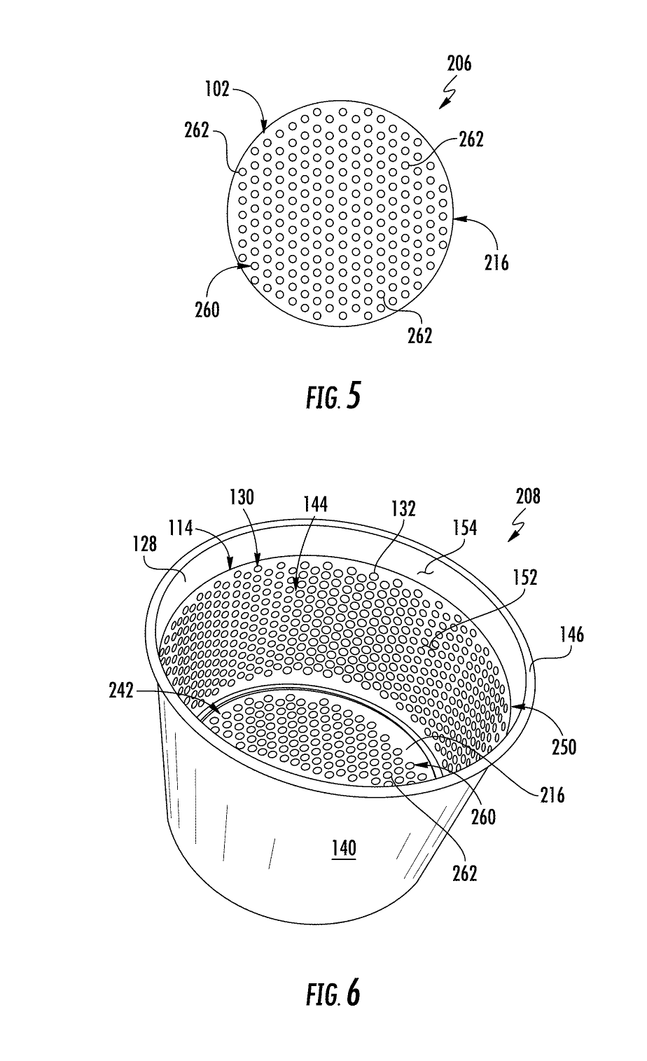

FIG. 1 is a plan view of the interior side 102 of a sidewall blank, generally indicated at 104, and FIG. 2 is a plan view of the interior side 102 of a bottom blank, generally indicated at 106, wherein the sidewall blank 104 and the bottom blank 106 are used in cooperation to form a container 108 (FIGS. 3 and 4) according to a first embodiment of the disclosure. In the illustrated embodiment, the container 108 is a cup, a tray, or a bowl with a curved (e.g., circular) perimeter for holding multiple (e.g., two) food items F1 and F2 (shown schematically in FIG. 4). In one embodiment, the food items F1, F2 can be arranged one on top of the other in the container 108 or could be in any other suitable arrangement. The container 108 could be alternatively shaped and/or could be alternatively formed without departing from the scope of this disclosure. For example, the container 108 could have any suitable regular or irregular shape without departing from the disclosure. Further, in an alternative embodiment, at least a portion of the container 108 could be press formed from a blank (not shown) without departing from the disclosure.

In the illustrated embodiment, each of the sidewall blank 104 and the bottom blank 106 can include a respective substrate or support layer 110, 112 and a respective microwave energy interactive layer 114, 116 (e.g., see the schematic cross-sectional view of the container 108 in FIG. 4). In one embodiment, each of the substrates 110, 112 can be formed from one or more layers of paperboard, cardboard, paper, polymeric sheet, and/or any other suitable material. For example, one or both of the substrates 110, 112 could include a paperboard layer with a polymer layer on one or both surfaces. In an exemplary embodiment, one or both of the substrates 110, 112 can include one or more materials that are transparent or generally transparent to microwave energy. In some embodiments, one or both of the substrates could be at least partially transparent to visible light. In the illustrated embodiment, the microwave energy interactive layer 114 is disposed on a portion of the interior surface 102 of the sidewall blank 104 and the microwave energy interactive layer 116 is disposed on the interior surface 102 of the bottom blank 106.

In one embodiment, the microwave energy interactive layers 114, 116 can be any suitable material or materials that block or shield (e.g., reflect) all or substantially all of the microwave energy incident on the portions of the container 108 that are covered by the microwave energy interactive material(s). For example, the microwave energy interactive layers could be a metal (e.g., aluminum and/or copper and/or other suitable materials) deposited, laminated, printed, and/or otherwise attached to the substrate in a suitably thick layer (e.g., 7 micrometers and/or other suitable thicknesses) to shield a portion of the interior of the container 108 from microwave energy. Either or both of the substrates 110, 112 and/or the microwave energy interactive materials 114, 116 could be omitted or could be otherwise configured without departing from the disclosure.

The active or microwave energy interactive elements included in the disclosure can include materials such as is common in MicroRite® containers available from Graphic Packaging International of Marietta, Ga. A microwave interaction layer can be commonly referred to as, or can have as one of its components, a foil, a microwave shield, or any other term or component that refers to a layer of material suitable for shielding microwave energy and/or causing heating in a microwave oven. Alternatively, the microwave interaction layer can be any suitable material that is laminated onto a substrate, which can be in the form of paperboard, cardboard, polymer, or any other suitable material. The microwave energy interactive elements could be other suitable microwave energy interactive materials or any other suitable material.

The sidewall blank 104 has a longitudinal axis L1 and a lateral axis L2. In the illustrated embodiment, the sidewall blank 104 comprises a top edge 120, a bottom edge 122, and a first end edge 124 and a second end edge 126 extending from the respective ends of the top and bottom edges 120, 122. In one embodiment, the top edge 120 can comprise a convex curve (e.g., having a radius of curvature extending away from the bottom edge 122), and the bottom edge 122 can comprise a concave curve (e.g., having a radius of curvature extending toward the top edge 120) so that the sidewall blank 104 forms a generally cylindrical sidewall that is at least partially tapered (e.g., the diameter at the top of the sidewall is greater than the diameter at the bottom of the sidewall) as shown by way of example in FIGS. 3 and 4. Further, as shown in FIG. 1, the end edges 124, 126 can be oblique, extending at an acute angle with respect to the lateral direction L2. Alternatively, one or more of the edges 120, 122, 124, 126 could be orthogonal or generally orthogonal and/or straight or generally straight and can, for example, form cylindrical sidewall that is not tapered (e.g., that has a generally constant diameter) without departing from the disclosure.

As shown in FIG. 1, the microwave energy interactive layer 114 of the sidewall blank 104 can extend from the first end edge 124 of the sidewall blank 104 with a marginal portion 128 of the sidewall blank extending along the top and bottom edges 120, 122 and the second end edge 126 of the sidewall blank and along three sides of the microwave energy interactive layer 114 (e.g., the marginal portion 128 generally can be U-shaped in one embodiment). Since the marginal portion 128 includes only the substrate 110 and is not covered by the microwave energy interactive layer 114, the marginal portion 128 is generally transparent to microwave energy for forming unshielded areas of the container 108 and/or to provide overlap areas. For example, an overlap portion can provide locations that can be overlapped with portions of the blanks 104, 106 that are coated with microwave energy interactive materials when the container 108 is formed to help avoid overlapping between two areas with microwave energy interactive materials, which can cause undesirable affects when the container 108 is exposed to microwave energy (e.g., charring).

In the illustrated embodiment, an arrangement 130 of voids or apertures 132 can be formed in the microwave energy interactive layer 114. In the embodiment of FIG. 1, each of the apertures 132 is generally circular and is arranged in staggered columns with a regular spacing between the apertures in the arrangement 130. Each of the apertures 132 can have a characteristic dimension (e.g., diameter) D as shown schematically in the detail view of FIG. 1A. In one embodiment, the diameter of the apertures 132 can be selected to be sufficiently small so that the transmission of microwave energy through the apertures 132 (and the microwave energy interactive layer 114) is nominal or completely prevented for a microwave oven (not shown) with a particular cutoff frequency. Accordingly, even with the apertures 132, the microwave energy interactive layer 114 reflects all or substantially all of the microwave energy incident on the microwave energy interactive layer 114 and acts as a shield against transmission of all or substantially all microwave energy incident on the microwave energy interactive layer 114 in the illustrated embodiment. In the illustrated embodiment, the apertures 132 can be spaced apart from one another by a distance that is substantially the same as the diameter D. The microwave energy interactive layer 114, including the apertures 132, could be omitted or could be otherwise shaped, arranged, positioned, and/or configured without departing from the disclosure. For example, the spacing of the apertures 132 in the arrangement 130 could be a different regular or irregular spacing and/or the apertures 132 could have a different regular or irregular shape and/or a different characteristic dimension (e.g., that is still determined according to the cutoff frequency of the microwave oven as described above).

In a particular example, a microwave oven could have a cutoff frequency of 2.45 gigahertz (GHz), wherein an aperture diameter D of 2 millimeters (mm) or less could be selected in order to prevent all or approximately all transmission of the microwave energy through the aperture 132. Further, in this example, aperture diameters of greater than 2 mm and less than 15 mm generally would permit transmission of a percentage of the microwave energy (e.g., a 4 mm aperture may permit an estimated 30% transmission of microwave energy) through the aperture for the cutoff frequency of 2.45 GHz, and an aperture diameter of 15 mm or greater generally may allow 100% transmission of microwave energy through the aperture for the cutoff frequency of 2.45 GHz. Accordingly, in the illustrated exemplary embodiment, the apertures 132 can have a 2 mm diameter for nominal transmission of microwave energy in a microwave oven with a cutoff frequency of 2.45 GHz, and the microwave energy interactive layer 114 acts as a shield in a portion of the container 108, wherein the shield prevents all or nearly all transmission of microwave energy even with the apertures 132. In the illustrated embodiment, the apertures 132 can be spaced apart by approximately 2 mm. The sidewall blank 104, including the substrate 110 and/or the microwave energy interactive material 114, could be omitted or could be otherwise shaped, arranged, positioned, and/or configured without departing from the disclosure.

Any of the dimensions and/or other parameters noted above or otherwise included in this disclosure are approximate and could be larger or smaller than noted or could be inside or outside the listed ranges without departing form the scope of the disclosure. All of the dimensional information presented herein is intended to be illustrative of certain aspects of the disclosure and is not intended to limit the scope of the disclosure, as various other embodiments of the disclosure could include dimensions that are greater than or less than the dimensions included herein.

In one embodiment, the benefits of the apertures 132 in the microwave energy interactive material include, but are not limited to, reducing the surface area of the microwave energy interactive layer 114, which can help reduce the arcing potential of the material without reducing the shielding of the material. In a particular example, a shielding microwave energy interactive material on a relatively small cup (e.g., with a diameter of approximately 62.5 mm) can be prone to undesirable arcing when exposed to microwave energy (e.g., due to currents induced in the microwave energy interactive material by the microwave energy), particularly when defects are included in the material. The reduction in the surface area of the microwave energy interactive layer 114 by the apertures 132 can help reduce the arcing potential of the material and can help make the material more tolerant of flaws.

As shown in FIG. 2, the bottom blank 106 can have a generally circular perimeter, and the entire interior surface 102 of the bottom blank 106 can be coated with the microwave energy interactive layer 116. As schematically shown in FIG. 4, the substrate 112 of the bottom blank 106 can support the microwave energy interactive layer 116. In the first exemplary embodiment, the microwave energy interactive layer 116 can be free of apertures and can shield generally all or all of the incident microwave energy on the bottom blank. The bottom blank 106, including the substrate 112 and/or the microwave energy interactive material 116, could be omitted or could be otherwise shaped, arranged, positioned, and/or configured without departing from the disclosure.

In the illustrated embodiment, the sidewall blank 104 and the bottom blank 106 can be formed into the carton 108 as shown in FIGS. 3 and 4. For example, the sidewall blank 104 can be bent and curved so that the areas adjacent the end edges 124, 126 overlap one another to form a sidewall 140 of the carton 108. In one embodiment, the area of the marginal portion 128 extending along the second end edge 126 and at least a portion of the area adjacent the first end edge 124, including a portion of the microwave energy interactive layer 114, can overlap one another. Accordingly, only one of the overlapping areas of the sidewall 140 includes the microwave energy interactive layer 114, which can help avoid unwanted charring of the container 108 and/or unwanted heating of the food items (e.g., by overlapping two areas with microwave energy interactive material). In the illustrated embodiment, the overlapped portions of the sidewall 140 can be glued or otherwise secured together.

As shown in FIGS. 3 and 4, the bottom blank 106 can be secured (e.g., glued) to the interior surface 102 of the sidewall 140 to form a bottom wall 142 of the container 108. In one embodiment, a marginal portion of the bottom wall 142 can be folded with respect to the central portion of the bottom wall and attached in face-to-face contact with the sidewall 140 (e.g., with the area of the marginal portion 128 extending along the bottom edge 122). In the illustrated embodiment, the bottom wall 142 and the sidewall 140 can extend around and form an interior 144 of the container 108, and the microwave energy interactive areas 114, 116 can cooperate to form a shield 150 that prevents propagation of all or nearly all of the microwave energy incident on the portions of the sidewall 140 and the bottom wall 142 that form the shield 150 into a shielded interior portion 152 of the interior 144. In addition, the area of the marginal portion 128 extending along the top of the container 108 can form an unshielded interior portion 154 of the container 108 in one exemplary embodiment.

In the illustrated embodiment, the bottom wall 142 can be spaced apart from the lower edge of the microwave energy interactive layer 114 of the sidewall 140 so that there is a small gap between the microwave energy interactive layers 114, 116. Alternatively, the bottom wall 142 could be adjacent and/or could partially overlap the microwave energy interactive layer 114. In one embodiment, the portion of the sidewall 140 adjacent the top edge 120 can be rolled over or otherwise formed into a rim 146 (FIGS. 3 and 4). The container 108 could be otherwise formed and/or could be otherwise shaped, arranged, and/or configured without departing from the disclosure. For example, the shielded interior portion 152 could be at least partially unshielded by the shield 150 and/or the unshielded interior portion 154 could be partially shielded. In another example, the container 108 could include a lid or another cover (not shown) such as a film cover or laminate lid, wherein the lid or other cover could be at least partially shielded or could be unshielded. In a further example, the container could be formed by press forming a single blank into a cup shape, for example, by molding (e.g., injection molding, blow molding, etc.), or by other suitable methods.

As shown in the schematic cross-sectional view of FIG. 4, the first food item F1 can be disposed in the interior 144 of the container 108 so that the food item F1 is at least partially contained in the shielded interior portion 152 of the carton 108. Additionally, the second food item F2 can be disposed at least partially in the unshielded interior portion 154 on top of the first food item F1. For example, in one embodiment, the first food item F1 can be disposed entirely within the shielded interior portion 152, and the second food item F2 can be disposed on top of the first food item F1 so that a portion (e.g., a small portion) of the second food item F2 is disposed in the shielded interior portion 152 and a portion (e.g., the majority) of the second food item F2 is disposed in the unshielded interior portion 154. In one embodiment, a portion of the second food item F2 can extend above the rim 146 of the container 108. The combination of the food items F1, F2 and the container 108 can generally form a package 156 as shown in FIG. 4. The food items F1, F2 could be otherwise shaped, arranged, positioned, and/or configured without departing from the disclosure. For example, the second food item F2 could be contained entirely within the unshielded interior portion 154. In a further example, a cover or lid (not shown) could be included to help retain the food items F1, F2 in the container before and/or during heating and/or to keep the food items sanitary. In another example, any suitable number of food items could be disposed in the shielded interior portion and/or the unshielded interior portion.

In an exemplary embodiment, the first food item F1 can be a food item that is not to be heated directly or that is substantially not to be heated directly by microwave energy and the food item F2 is for being at least partially heated directly by microwave energy when the package 156 is exposed to microwave energy. In one example, the first food item F1 could be ice cream and the second food item F2 could be cake. In this example, the package 156 is kept frozen until a user is ready to eat the food items. It is desirable in this example for the ice cream to remain frozen or substantially frozen and for the cake to be heated. Accordingly, the ice cream F1 is disposed in the shielded interior portion 152 and the cake F2 is disposed in the unshielded interior portion 154. When the package 156 is removed from a freezer, positioned in a microwave oven, and exposed to microwave energy, for example, the microwave energy is shielded/reflected from the ice cream F1 by the shield 150 and can directly heat the cake F2 (e.g., via the top of the container 108 and/or via the marginal portion 128 of the sidewall extending along the unshielded interior portion 154). The microwave energy can heat the cake F2 while the ice cream F1 can remain substantially frozen. The user can then enjoy the combination of the thawed and/or heated cake F2 and the substantially frozen ice cream F1. In other examples, the first food item F1 can be substantially retained at an initial temperature while the second food item F2 is heated, melted, thawed, etc. by direct or indirect microwave energy when the package 156 is exposed to microwave energy. Other food items and/or other methods of use could be used without departing from the disclosure. For example, the substrate 110 of the sidewall 140 could be an at least partially transparent material so that the food item F1 can be observed through the transparent or translucent substrate 110 and the apertures 132 in the shield 150 during exposure to microwave energy.

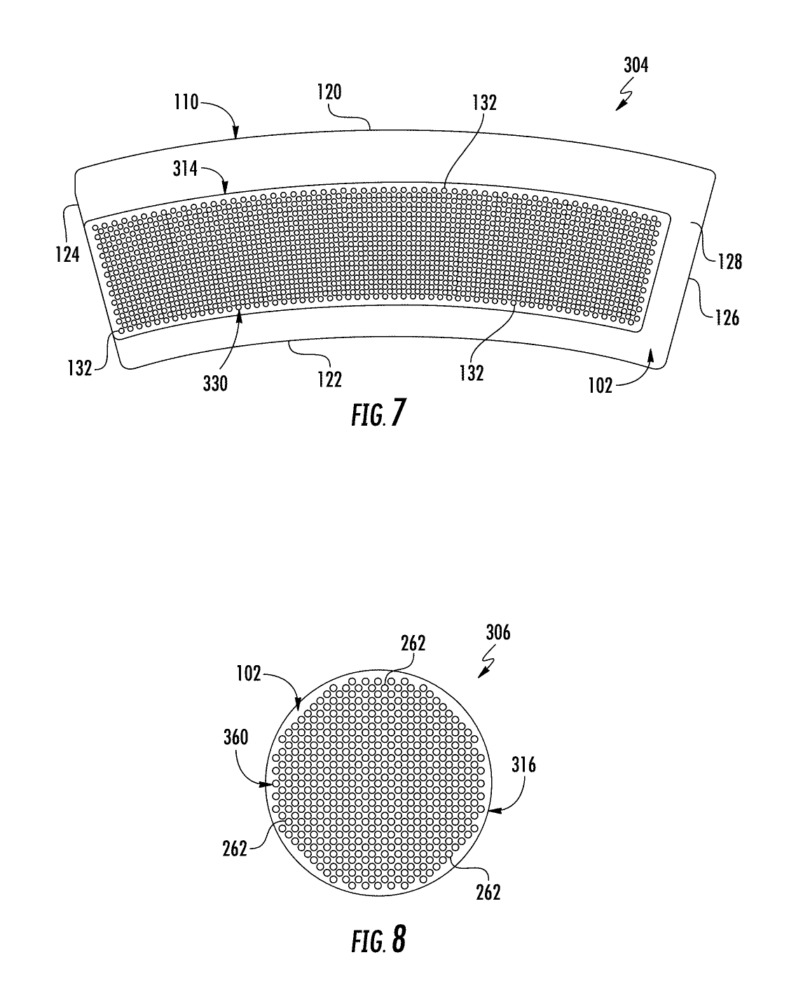

FIG. 5 is a plan view of a bottom blank 206 for being combined with the sidewall blank 104 of FIG. 1 to form a container 208 (FIG. 6) according to a second embodiment of the disclosure. The second embodiment is generally similar to the first embodiment, except for variations noted and variations that will be apparent to one of ordinary skill in the art. Accordingly, similar or identical features of the embodiments have been given like or similar reference numbers. As shown in FIG. 5, the bottom blank 206 includes a microwave energy interactive layer 216 on its interior surface 102, wherein the microwave energy interactive layer 216 includes an arrangement 260 of apertures 262. In the illustrated embodiment, the arrangement 260 and the apertures 262 are similar to the arrangement 130 and the apertures 132, respectively of the sidewall blank 104 of the first embodiment (FIG. 1). Accordingly, when the container 208 is formed as shown in FIG. 6, the bottom blank 206 forms a bottom wall 242 that cooperates with the sidewall 140 to form the interior 144 of the container 208. Additionally, the microwave energy interactive layers 114, 216 of the sidewall 140 and the bottom wall 242 cooperate to form the shield 250 of the container 208 and to at least partially define the shielded interior portion 152. The bottom blank 206 and/or the container 208 could be otherwise shaped, arranged, positioned, and/or configured without departing from the disclosure.

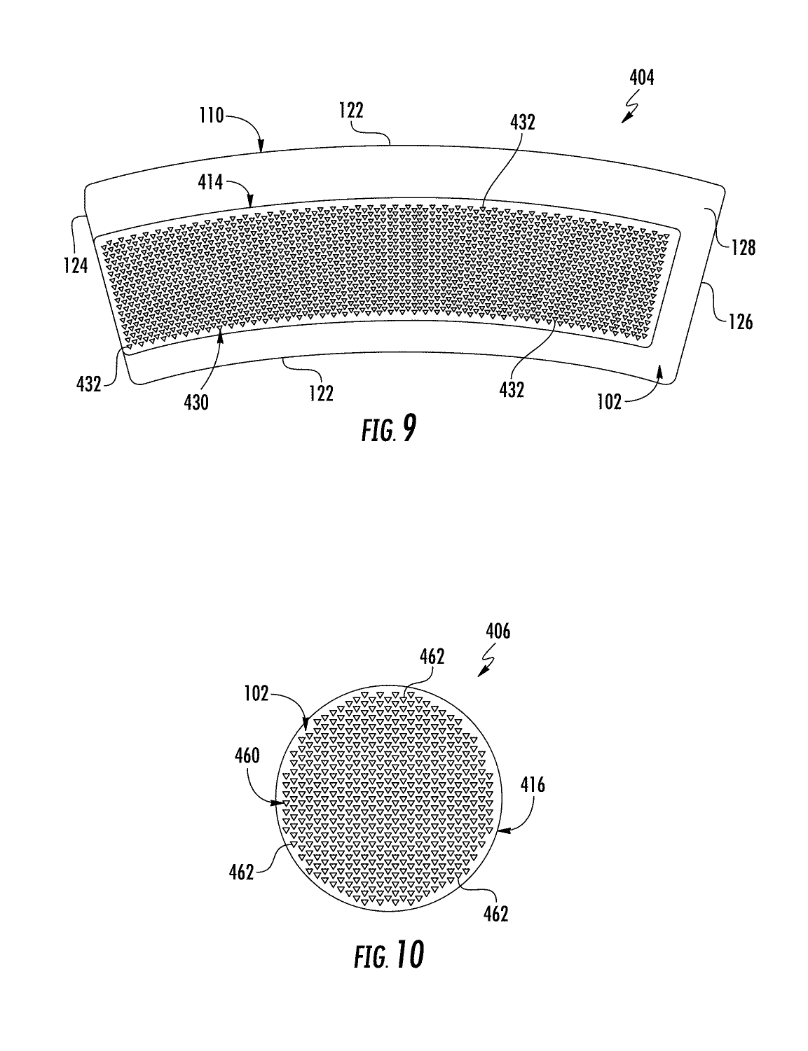

FIGS. 7 and 8 are plan views of a sidewall blank 304 and a bottom blank 306, respectively, for cooperating to form a container (not shown) according to a third embodiment of the disclosure. The third embodiment is generally similar to the second embodiment and the first embodiment, except for variations noted and variations that will be apparent to one of ordinary skill in the art. Accordingly, similar or identical features of the embodiments have been given like or similar reference numbers. As shown in FIG. 7, the sidewall blank 304 includes a microwave energy interactive layer 314 with the apertures 132 disposed in an alternative arrangement 330. The arrangement 330 is similar to the arrangement 130 of FIG. 1, except the apertures 132 are positioned closer together in the microwave energy interactive layer 314. For example, in one embodiment, the apertures 132, which can have a diameter of 2 mm, could be spaced apart by approximately 0.5 mm in the arrangement 330, wherein the apertures 132 are be spaced apart by approximate 2 mm in the arrangement 130 of FIG. 1. As shown in FIG. 8, the bottom blank 306 can include a microwave energy interactive layer 316 with an arrangement 360 of the apertures 262. In the illustrated embodiment, the arrangement 360 is generally the same as or similar to the arrangement 330 of the apertures 132 in the sidewall blank 304 of FIG. 7. The sidewall blank 304 and the bottom blank 306 can form a respective sidewall and bottom wall in a carton (not shown) similar to the carton 208 of the embodiment shown in FIG. 6. The sidewall blank 304, the bottom blank 306, and/or a container formed therefrom could be otherwise shaped, arranged, positioned, and/or configured without departing from the disclosure. For example, the apertures 132 could be disposed in other arrangements (e.g., having any suitable regular or irregular spacing) and/or could have other shapes (e.g., ovals, regular or irregular polygons, etc.).

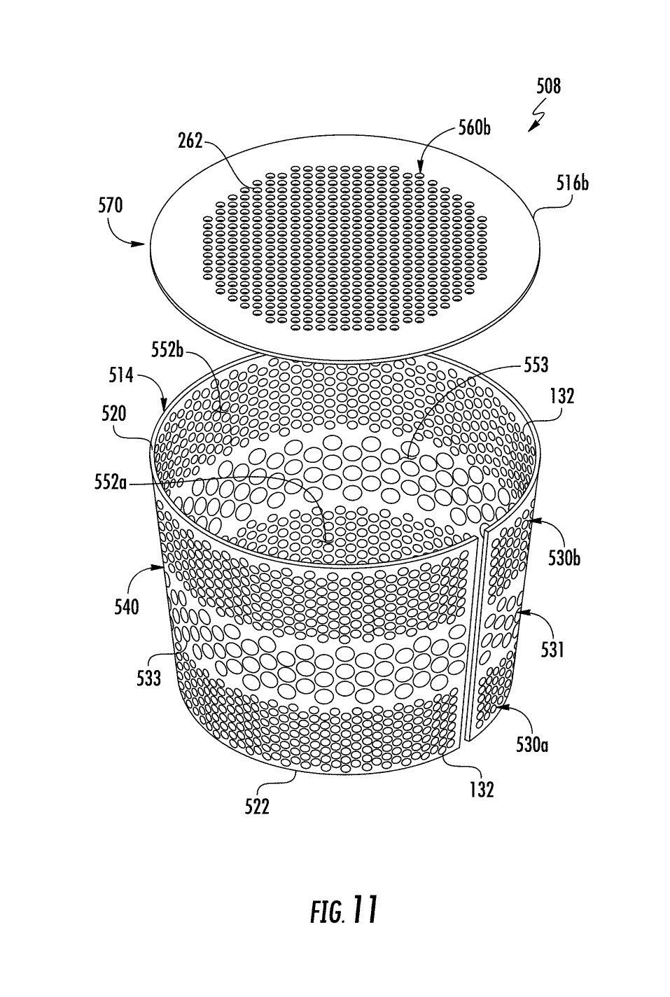

FIGS. 9 and 10 are plan views of a sidewall blank 404 and a bottom blank 406, respectively, for cooperating to form a container (not shown) according to a fourth embodiment of the disclosure. The fourth embodiment is generally similar to the previous embodiments, except for variations noted and variations that will be apparent to one of ordinary skill in the art. Accordingly, similar or identical features of the embodiments have been given like or similar reference numbers. As shown in FIG. 9, the sidewall blank 404 includes a microwave energy interactive layer 414 with an arrangement 430 of apertures 432, which have a triangular shape. In the illustrated embodiment, the triangles are equilateral triangles that are evenly spaced apart from one another. Alternatively, the apertures 432 could have other triangular or polygonal shapes (e.g., squares and other rectangles, trapezoids, octagons, etc.) and/or could have different and/or irregular spacing. As shown in FIG. 10, the bottom blank 406 can include a microwave energy interactive layer 416 with an arrangement 460 of triangular apertures 462, which can be similar or identical to the arrangement 430 and the triangular apertures 432, respectively, of the sidewall blank 404 of FIG. 9. The apertures 432, 462 each can have a characteristic dimension, which can be similar to the diameter D of the aperture 132 (FIG. 1A). For example, the characteristic dimension of the apertures 432 and/or the apertures 462 could be the length of a side of the triangle or the spacing of a vertex from a midpoint of an opposing side of the triangle. In one embodiment, the characteristic dimension of the apertures 432, 462 can be selected to be sufficiently small to prevent or to substantially prevent transmission of microwave energy through the microwave energy interactive material 414, 416 for the cutoff frequency of a particular microwave oven. The sidewall blank 404 and the bottom blank 406 can form a respective sidewall and bottom wall in a carton similar to the carton 208 of the embodiment shown in FIG. 6, for example. The sidewall blank 404, the bottom blank 406, and/or a container formed therefrom could be otherwise shaped, arranged, positioned, and/or configured without departing from the disclosure.

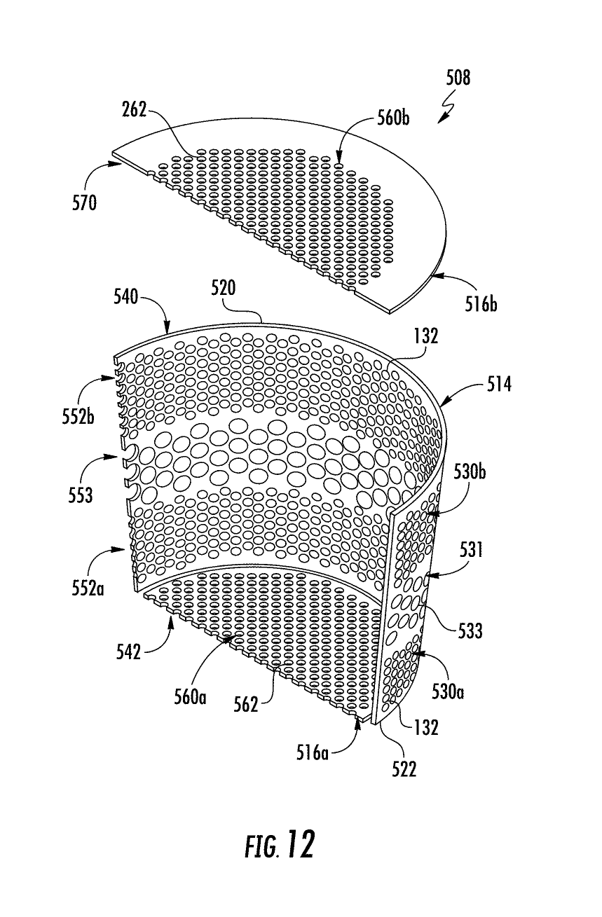

FIGS. 11 and 12 are a schematic perspective view and a schematic perspective cross-sectional view, respectively, of the microwave energy interactive materials of a container 508 according to a fifth embodiment of the disclosure. The fifth embodiment is generally similar to the previous embodiments, except for variations noted and variations that will be apparent to one of ordinary skill in the art. Accordingly, similar or identical features of the embodiments have been given like or similar reference numbers. As shown in FIGS. 11 and 12, the container 508 includes a sidewall 540, a bottom wall 542, and a top wall or lid 570. In the illustrated embodiment, the sidewall 540 includes a microwave energy interactive material or layer 514 mounted (e.g., laminated, printed, glued, deposited, etc.) on a substrate (e.g., paperboard, polymer film, molded polymer, or other suitable material) (not shown in the schematic views of FIGS. 11 and 12, which only show the microwave energy interactive layers of the sidewall 540, the bottom wall 542, and the lid 570). In addition, as shown in FIGS. 11 and 12, the bottom wall 542 and the lid 570 each includes a respective microwave energy interactive material or layer 516a, 516b mounted (e.g., laminated, printed, glued, deposited, etc.) on a substrate (e.g., paperboard, polymer film, molded polymer, or other suitable material) (not shown). In one embodiment, the microwave energy interactive material or layer 516a, 516b can include respective arrangements 560a, 560b of the apertures 262, wherein the arrangements 560a, 560b are similar to the arrangement 260 as shown in the embodiment of FIG. 5. In the illustrated embodiment, the arrangement 560a covers a larger area than the arrangement 560b. The sidewall 540, the bottom wall 542, and/or the lid 570 could be omitted or could be otherwise shaped, arranged, positioned, and/or configured without departing from the disclosure.

As shown in FIGS. 11 and 12, the microwave energy interactive material or layer 514 of the sidewall 540 includes a first arrangement 530a of apertures 132 extending in a first or bottom region of the microwave energy interactive layer adjacent a bottom edge 522 of the sidewall 540 and a second arrangement 530b of apertures 132 extending in a second or top region of the microwave energy interactive layer adjacent a top edge 520 of the sidewall. The arrangements of apertures 530a, 530b can be similar to the arrangements 130, 330 of the embodiments of respective FIGS. 1 and 7, for example. Alternatively, the apertures 132 could have different shapes and/or arrangements without departing from the disclosure. Accordingly, the first arrangement 530a of apertures 132 and the microwave energy interactive layer 514 can cooperate with the arrangement 560a of apertures 262 and the microwave energy interactive layer 516a on the bottom wall 542 to form a first or lower shielded interior portion 552a of the container 508, and the second arrangement 530b of apertures 132 and the microwave energy interactive layer 514 can cooperate with the arrangement 560b of apertures 262 and the microwave energy interactive layer 516b on the lid 570 to form a second or upper shielded interior portion 552b of the container 508.

In the illustrated embodiment, the sidewall 540 further can include an arrangement 531 of apertures 533 extending in a third or intermediate region of the microwave energy interactive layer disposed between the first arrangement 530a in the bottom region and the second arrangement 530b in the top region. The apertures 533 can have a larger diameter than the apertures 132. In one exemplary embodiment, the container 508 can be for use in a microwave oven having a cutoff frequency of 2.45 GHz, and, accordingly, the apertures 132 can have a diameter of 2 mm. In this example, the apertures 533 can have a diameter of 4 mm in order to allow transmission of an estimated 30% of the microwave energy incident on the apertures 533 in the microwave oven having the 2.45 GHz cutoff frequency.

As shown in FIGS. 11 and 12, the arrangement 531 forms a partially shielded (or partially unshielded) interior portion 553 disposed between the shielded interior portions 552a, 552b. Accordingly, a food item (not shown) that is for being at least partially heated directly by microwave energy can be disposed in the central partially shielded interior portion 553 between two food items (not shown) that are for remaining or substantially remaining at their initial temperatures while the first food item is heated and that are disposed in the respective shielded interior portions 552a, 552b. In one embodiment, the food items in the shielded interior portions 552a, 552b can be two different food items or two portions of the same food item. In one example, the foods in the shielded interior portions 552a, 552b can be a crumb coating and ice cream, respectively, and the heated food item in the partially shielded interior portion 553 can be cake disposed therebetween.

The container 508 could be otherwise shaped, arranged, positioned, and/or configured without departing from the disclosure. For example, the container could include any suitable number of shielded interior portions, partially shielded interior portions, and/or unshielded interior portions in any suitable arrangement.

Any of the features of the various embodiments of the disclosure can be combined with, replaced by, or otherwise configured with other features of other embodiments of the disclosure without departing from the scope of this disclosure.

Optionally, one or more portions of the blank or other constructs described herein or contemplated hereby may be coated with varnish, clay, or other materials, either alone or in combination. The coating may then be printed over with product advertising or other information or images. The blanks or other constructs also may be selectively coated and/or printed so that less than the entire surface area of the blank or substantially the entire surface area of the blank may be coated and/or printed.

In an alternative embodiment, any of the blanks, containers, or other constructs of this disclosure may optionally include one or more features that alter the effect of microwave energy during the heating or cooking of a food item that is associated with the tray or other construct. For example, the blank, tray, container, or other construct may be formed at least partially from one or more microwave energy interactive elements (hereinafter sometimes referred to as “microwave interactive elements”) that promote heating, browning and/or crisping of a particular area of the food item, shield a particular area of the food item from microwave energy to prevent overcooking thereof, or transmit microwave energy towards or away from a particular area of the food item. Each microwave interactive element comprises one or more microwave energy interactive materials or segments arranged in a particular configuration to absorb microwave energy, transmit microwave energy, reflect microwave energy, or direct microwave energy, as needed or desired for a particular construct and food item.

In the case of a susceptor or shield, the microwave energy interactive material may comprise an electroconductive or semiconductive material, for example, a vacuum deposited metal or metal alloy, or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In other embodiments, the microwave energy interactive material may be carbon-based, for example, as disclosed in U.S. Pat. Nos. 4,943,456, 5,002,826, 5,118,747, and 5,410,135.

In still other embodiments, the microwave energy interactive material may interact with the magnetic portion of the electromagnetic energy in the microwave oven. Correctly chosen materials of this type can self-limit based on the loss of interaction when the Curie temperature of the material is reached. An example of such an interactive coating is described in U.S. Pat. No. 4,283,427.

The use of other microwave energy interactive elements is also contemplated. In one example, the microwave energy interactive element may comprise a foil or high optical density evaporated material having a thickness sufficient to reflect a substantial portion of impinging microwave energy. Such elements typically are formed from a conductive, reflective metal or metal alloy, for example, aluminum, copper, or stainless steel, in the form of a solid “patch” generally having a thickness of from about 0.000285 inches to about 0.005 inches, for example, from about 0.0003 inches to about 0.003 inches. Other such elements may have a thickness of from about 0.00035 inches to about 0.002 inches, for example, 0.0016 inches.

In some cases, microwave energy reflecting (or reflective) elements may be used as shielding elements where the food item is prone to scorching or drying out during heating. In other cases, smaller microwave energy reflecting elements may be used to diffuse or lessen the intensity of microwave energy. One example of a material utilizing such microwave energy reflecting elements is commercially available from Graphic Packaging International, Inc. (Marietta, Ga.) under the trade name MicroRite® packaging material. In other examples, a plurality of microwave energy reflecting elements may be arranged to form a microwave energy distributing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy. The breaks or apertures may extend through the entire structure, or only through one or more layers. The number, shape, size, and positioning of such breaks or apertures may vary for a particular application depending on the type of construct being formed, the food item to be heated therein or thereon, the desired degree of heating, browning, and/or crisping, whether direct exposure to microwave energy is needed or desired to attain uniform heating of the food item, the need for regulating the change in temperature of the food item through direct heating, and whether and to what extent there is a need for venting.

By way of illustration, a microwave energy interactive element may include one or more transparent areas to effect dielectric heating of the food item. However, where the microwave energy interactive element comprises a susceptor, such apertures decrease the total microwave energy interactive area, and therefore, decrease the amount of microwave energy interactive material available for heating, browning, and/or crisping the surface of the food item. Thus, the relative amounts of microwave energy interactive areas and microwave energy transparent areas may be balanced to attain the desired overall heating characteristics for the particular food item.

As another example, one or more portions of a susceptor may be designed to be microwave energy inactive to ensure that the microwave energy is focused efficiently on the areas to be heated, browned, and/or crisped, rather than being lost to portions of the food item not intended to be browned and/or crisped or to the heating environment. Additionally or alternatively, it may be beneficial to create one or more discontinuities or inactive regions to prevent overheating or charring of the food item and/or the construct including the susceptor.

As still another example, a susceptor may incorporate one or more “fuse” elements that limit the propagation of cracks in the susceptor, and thereby control overheating, in areas of the susceptor where heat transfer to the food is low and the susceptor might tend to become too hot. The size and shape of the fuses may be varied as needed. Examples of susceptors including such fuses are provided, for example, in U.S. Pat. No. 5,412,187, U.S. Pat. No. 5,530,231, U.S. Patent Application Publication No. US 2008/0035634A1, published Feb. 14, 2008, and PCT Application Publication No. WO 2007/127371, published Nov. 8, 2007, each of which is incorporated by reference herein in its entirety.

The blanks according to the present invention can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blanks. The blanks may also be coated with, for example, a moisture barrier layer, on either or both sides of the blanks.

In accordance with the exemplary embodiments, the blanks and/or other constructs may be constructed of paperboard of a caliper such that it is heavier and more rigid than ordinary paper. The blanks can also be constructed of other materials, such as cardboard, hard paper, or any other material having properties suitable for enabling the carton package to function at least generally as described above.

The foregoing description illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, and alterations, etc., of the above-described embodiments. Additionally, the disclosure shows and describes only selected embodiments, but various other combinations, modifications, and environments are contemplated and are within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A container for holding at least a first food item and a second food item during exposure to microwave energy in a microwave oven having a cutoff frequency, the container comprising:
a sidewall extending at least partially around an interior of the container, the sidewall comprising at least a substrate layer and a microwave energy interactive layer;
a shielded interior portion of the interior of the container, the shielded interior portion being at least partially defined by at least the microwave energy interactive layer of the sidewall, the shielded interior portion being for at least partially receiving the first food item; and
an at least partially unshielded interior portion of the interior of the container, the at least partially unshielded interior portion being at least partially defined by the sidewall, the at least partially unshielded interior portion being for at least partially receiving the second food item;
wherein a plurality of apertures extend through at least the microwave energy interactive layer, each aperture of the plurality of apertures has a characteristic dimension that is selected based on the cutoff frequency of the microwave oven to be sufficiently small so that substantially all microwave energy incident on the microwave energy interactive layer is substantially prevented from passing through the apertures.

2. The container of claim 1, wherein the apertures of the plurality of apertures are disposed in an arrangement in which the apertures are generally evenly spaced from one another.

3. The container of claim 2, wherein each of the apertures is spaced apart from the respectively adjacent apertures by approximately the characteristic diameter of the apertures.

4. The container of claim 1, wherein each of the apertures is generally circular and the characteristic dimension is the diameter of the circular apertures.

5. The container of claim 4, wherein the diameter of each of the apertures is approximately 2 mm and the cutoff frequency is approximately 2.45 GHz.

6. The container of claim 5, wherein each of the apertures is spaced apart from the respectively adjacent apertures by approximately 2 mm.

7. The container of claim 5, wherein each of the apertures is spaced apart from the respectively adjacent apertures by approximately 0.5 mm.

8. The container of claim 1, wherein each of the apertures comprises a triangular shape.

9. The container of claim 1, wherein the at least partially unshielded interior portion is at least partially defined by a marginal portion of the substrate layer extending between the microwave energy interactive layer and an upper rim of the container, the marginal portion being generally free of the microwave energy interactive layer.

10. The container of claim 9, further comprising a bottom wall further at least partially defining the interior of the container.

11. The container of claim 10, wherein the microwave energy interactive layer and the substrate layer of the sidewall are a first microwave energy interactive layer and a first substrate layer, respectively, and the bottom wall comprises a second substrate layer and a second microwave energy interactive layer, the shielded interior portion being further at least partially defined by the second microwave energy interactive layer.

12. The container of claim 1, wherein the microwave energy interactive layer and the substrate layer of the sidewall are a first microwave energy interactive layer and a first substrate layer, respectively, and the container further comprises a bottom wall further at least partially defining the interior of the container, the bottom wall comprising a second substrate layer and a second microwave energy interactive layer, the shielded interior portion being further at least partially defined by the second microwave energy interactive layer.

13. The container of claim 12, wherein the plurality of apertures is a first plurality of apertures, and a second plurality of apertures extends through at least the second microwave energy interactive layer in the bottom wall.

14. The container of claim 1, wherein the shielded interior portion of the container is at least partially defined by a first region of the microwave energy interactive layer, the at least partially unshielded interior portion of the container is at least partially defined by a second region of the microwave energy interactive layer, and the plurality of apertures extends in the first region.

15. The container of claim 14, wherein the plurality of apertures is a first plurality of apertures, the characteristic dimension of the apertures of the first plurality of apertures is a first characteristic dimension, the second region comprises a second plurality of apertures, and each aperture of the second plurality of apertures comprises a second characteristic dimension that is larger than the first characteristic dimension so that the second plurality of apertures allow propagation of a percentage of the microwave energy incident on the second region of the microwave energy interactive layer through the apertures of the second plurality of apertures.

16. The container of claim 14, wherein the shielded interior portion of the container is a first shielded interior portion, the container further comprises a second shielded interior portion at least partially defined by a third region of the microwave energy interactive layer, and the second shielded interior portion is spaced apart from the first shielded interior portion by at least the at least partially unshielded interior portion.

17. The container of claim 16, wherein the plurality of apertures is a first plurality of apertures, the third region comprises a second plurality of apertures, and the apertures of the second plurality of apertures are substantially identical to the apertures of the first plurality of apertures.

18. The container of claim 16, further comprising a bottom wall further at least partially defining the first shielded interior portion of the container and a lid further at least partially defining the second shielded interior portion of the container.

19. A method of forming a container for holding at least a first food item and a second food item during exposure to microwave energy in a microwave oven having a cutoff frequency, the method comprising:
obtaining a sidewall blank comprising at least a substrate layer and a microwave energy interactive layer, the microwave energy interactive layer comprising a plurality of apertures, each extending through at least the microwave energy interactive layer, each aperture of the plurality of apertures has a characteristic dimension that is selected based on the cutoff frequency of the microwave oven to be sufficiently small so that substantially all microwave energy incident on the microwave energy interactive layer is substantially prevented from passing through the apertures; and
forming a sidewall extending at least partially around an interior of the container with the sidewall blank, the forming the sidewall comprising
forming a shielded interior portion of the interior of the container, the shielded interior portion being at least partially defined by the microwave energy interactive layer of the sidewall, the shielded interior portion being for at least partially receiving the first food item; and
forming an at least partially unshielded interior portion of the interior of the container, the at least partially unshielded interior portion being at least partially defined by the sidewall, the at least partially unshielded interior portion being for at least partially receiving the second food item.

20. The method of claim 19, wherein each of the apertures of the plurality of apertures is spaced apart from the respectively adjacent apertures by approximately the characteristic diameter of the apertures.

21. The method of claim 19, wherein each of the apertures is generally circular and the characteristic dimension is the diameter of the circular apertures.

22. The method of claim 19, wherein each of the apertures comprises a triangular shape.

23. The method of claim 19, wherein the at least partially unshielded interior portion is at least partially defined by a marginal portion of the substrate layer extending between the microwave energy interactive layer and an upper rim of the container, the marginal portion being generally free of the microwave energy interactive layer.

24. The method of claim 19, wherein the microwave energy interactive layer and the substrate layer of the sidewall are a first microwave energy interactive layer and a first substrate layer, respectively, and the method further comprises obtaining a bottom blank and forming a bottom wall from the bottom blank, the bottom wall further at least partially defining the interior of the container, the bottom wall comprising a second substrate layer and a second microwave energy interactive layer, the shielded interior portion being further defined by the second microwave energy interactive layer.

25. The method of claim 24, wherein the plurality of apertures is a first plurality of apertures, and a second plurality of apertures extends through at least the second microwave energy interactive layer in the bottom blank.

26. The method of claim 24, wherein the forming the bottom wall comprises attaching the bottom blank to the sidewall proximate the first microwave energy interactive layer.

27. A package for being exposed to microwave energy in a microwave oven having a cutoff frequency, the package comprising:
a container comprising a sidewall extending at least partially around an interior of the container, the sidewall comprising at least a substrate layer and a microwave energy interactive layer, wherein
a shielded interior portion of the interior of the container is at least partially defined by the microwave energy interactive layer of the sidewall,
an at least partially unshielded interior portion of the interior of the container is at least partially defined by the sidewall, and
a plurality of apertures extending through at least the microwave energy interactive layer, each aperture of the plurality of apertures has a characteristic dimension that is selected based on the cutoff frequency of the microwave oven to be sufficiently small so that substantially all microwave energy incident on the microwave energy interactive layer is substantially prevented from passing through the apertures;
a first food item at least partially disposed in the shielded interior portion for being shielded from microwave energy incident on the container by at least the microwave energy interactive layer; and
a second food item at least partially disposed in the at least partially unshielded interior portion.

28. The package of claim 27, wherein each of the apertures is generally circular and the characteristic dimension is the diameter of the circular apertures.

29. The package of claim 27, wherein each of the apertures comprises a triangular shape.

30. The package of claim 27, wherein the at least partially unshielded interior portion is at least partially defined by a marginal portion of the substrate layer extending between the microwave energy interactive layer and an upper rim of the container, the marginal portion being generally free of the microwave energy interactive layer.

31. The package of claim 27, wherein the microwave energy interactive layer and the substrate layer of the sidewall are a first microwave energy interactive layer and a first substrate layer, respectively, and the container further comprises a bottom wall, the bottom wall further at least partially defining the interior of the container, the bottom wall comprising a second substrate layer and a second microwave energy interactive layer, the shielded interior portion being further defined by the second microwave energy interactive layer.

32. A method comprising:
obtaining a container comprising a sidewall extending at least partially around an interior of the container, the sidewall comprising at least a substrate layer and a microwave energy interactive layer, wherein
a shielded interior portion of the interior of the container is at least partially defined by at least the microwave energy interactive layer of the sidewall,
an at least partially unshielded interior portion of the interior of the container is at least partially defined by the sidewall, and
a plurality of apertures extends through at least the microwave energy interactive layer;
disposing a first food item in the shielded interior portion;
disposing a second food item in the at least partially unshielded interior portion; and
exposing the container to microwave energy in a microwave oven having a cutoff frequency, wherein each aperture of the plurality of apertures has a characteristic dimension that is selected based on the cutoff frequency of the microwave oven to be sufficiently small so that the microwave energy interactive layer and the apertures substantially shield the first food item from the microwave energy.

33. The method of claim 32, wherein each of the apertures is generally circular and the characteristic dimension is the diameter of the circular apertures.

34. The method of claim 32, wherein each of the apertures comprises a triangular shape.

35. The method of claim 32, wherein the at least partially unshielded interior portion is at least partially defined by a marginal portion of the substrate layer extending between the microwave energy interactive layer and an upper rim of the container, the marginal portion being generally free of the microwave energy interactive layer.

36. The method of claim 32, wherein the microwave energy interactive layer and the substrate layer of the sidewall are a first microwave energy interactive layer and a first substrate layer, respectively, and the container further comprises a bottom wall, the bottom wall further at least partially defining the interior of the container, the bottom wall comprising a second substrate layer and a second microwave energy interactive layer, the shielded interior portion being further defined by the second microwave energy interactive layer.

37. The method of claim 36, wherein the plurality of apertures is a first plurality of apertures, and a second plurality of apertures extends through at least the second microwave energy interactive layer in the bottom wall.

38. The method of claim 32, wherein the first food item and the second food item are frozen prior to the exposing the container to the microwave energy, the exposing the container to the microwave energy comprises heating the second food item with the microwave energy, and the first food item is substantially frozen after the exposing the container to the microwave energy.
